(19) United States
(12) Patent Application Publication
(10) Pub. No.: US 2002/0174092 A1
(43) Pub. Date: Nov. 21, 2002

(54) Graphical editing of driver log data

(76) Inventors: Bruce A. Olson, Bedford, NH (US); Frank J. Perreault, Danville, NH (US)

Correspondence Address: DEVINE, MILLIMET & BRANCH, P.A., 111 AMHERST STREET, BOX 719, MANCHESTER, NH, 03105, US

(21) Appl. No.: 09/859,087

(22) Filed: May 16, 2001

(51) Int. Cl. G06F 7/00

(52) U.S. Cl. 707/1

(57) ABSTRACT

This invention is a data editor for modifying recorded driver's log data based on a chosen finite set of events. The data editor includes a data transfer means for loading the recorded driver's log data into the editor. The data editor also has a graphing means for taking the recorded driver's log data and creating a graphic display. Finally, the data editor includes a modifying means for graphically modifying the recorded driver's log data within a predetermined set of rules. This invention is also a novel data editing method. The first step in the method is transferring the recorded driver's log data into a data editor. The next step is graphing the recorded driver's log data on an electronic display. The final step is modifying the recorded driver's log data graphically within preset parameters.

### FIELD OF THE INVENTION

This invention is in the field of data editors. Specifically, this invention is in the field of graphical editing of electronically recorded data. More specifically, this invention is in the field of software for graphical editing of electronically recorded data with preprogrammed limitations for statistical accuracy.

### BACKGROUND OF THE INVENTION

Today's vehicle-based computers can collect many types of data including data that is generated by driver input. One type of data that is often recorded in vehicle-based computers, particularly truck-based computers, is a log of driver activity. This log is normally filled with events such as a drive start-event or end-event or an off-duty start-event or end-event. It is possible for the driver to make errors in the data recording that are not noticed or corrected until the data is reviewed back at the office.

There are two methods used to allow time related data to be recorded and edited that are currently employed. The first editor method is for data recorded “Episodes,” with a single event that includes type and duration. This editor simply enforces a rule that no two episodes may overlap. Unfortunately, this method creates problems because a driver cannot transmit the event while it is happening, but must wait until the episode duration is completed before sending it. If, for example, a driver is currently off duty, the driver could not transmit that event until the off duty episode ended, possibly days after it had begins. Also, this off duty event may end in another vehicle, so the total event could not be reconstructed with out separate start off duty and end off duty events. Therefore, an editing method that is not dependant on episode durations is desirable

The second method for recording data in events is direct editing of the event data. This method can create overlaps when the user pushes back an end-event without pushing back the simultaneous start-event. This overlap error can result in a driver having more than 24 hours of event data in a day, which is an obvious error. In this way, this method is dependant on the user to assure that overlaps do not occur. A means is needed to assist the user in avoiding overlaps.

Very often driver log data is time stamped as events rather than episodes with a correlated time span, and certain data, such as the Department of Transportation (DOT) driver log data, is controlled by specific rules, in which certain events cannot follow others. For example, a drive start event cannot be followed by an off-duty start-event, but must be followed by a drive end event. The drive end-event, must then be immediately/simultaneously followed by another (or the same) event type start-event. There is no current means to edit the data to assure that these rules are followed. An intuitive means to edit the data, which constrains the user to keep them from causing events to happen in the wrong order, is needed.

### SUMMARY OF THE INVENTION

This invention results from the realization that driver log data can be edited without using durations and without the option of violating driver log data rules by designing a graphical editor which presents a fixed number of states and forces the user to avoid data overlap programmatically, by constraining the editing so that no overlaps can occur.

Therefore it is an object of this invention to design a data editor that does not require recording durations.

It is a further object of this invention to design a data editor that is graphical and thereby easier to use.

It is a further object of this invention to design a data editor that does not allow the user to create data overlaps

The invention herein disclosed is a graphical editor, which presents a fixed number of states and forces the user obey data rules programmatically. Episode durations are not recorded. Rather, the start and end-events are recorded, then transferred from the database to the editor, and images of episode durations are created graphically in the editor. By graphically sliding data along a graph to change states and episode durations, events are edited in the database so that there are no overlaps. An episode is edited graphically with the editor, forcing the user to select from a permitted set of state transitions. The underlying start and end events are then modified, deleted, or added in the database as a result of a series of graphical episode duration modifications.

### BRIEF DESCRIPTION OF THE DRAWINGS

The novel features believed characteristic of the invention are set forth in the claims. The invention itself however, as well as other features and advantages thereof, will be best understood by reference to the description which follows, read in conjunction with the accompanying drawings, wherein:

FIG. 1 shows a one-line diagram of one embodiment of the data editor.

FIG. 2 shows a sample graphic display from the graphical editor.

FIG. 3 shows the sample graphic display of FIG. 2 with a single modified event.

FIG. 4 shows the sample graphic display of FIG. 2 with a modified stop time on one event and a corresponding modified start time for a second event.

FIG. 5 shows a flow diagram of one embodiment of the data editing method.

FIG. 6 shows a flow diagram of one embodiment of the graphic modifying portion of the data editing method.

FIG. 7 shows a flow diagram of another embodiment of the graphic modifying portion of the data editing method.

FIG. 8 shows one of the sample graphic displays with a duration selected.

FIG. 9 shows a flow diagram of another embodiment of the data editing method.

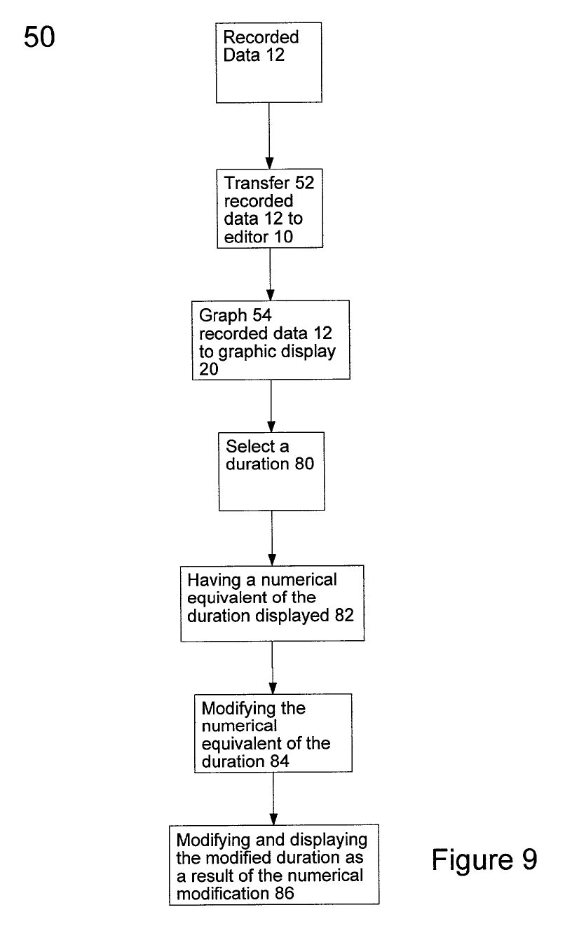

### DETAILED DESCRIPTION OF THE INVENTION

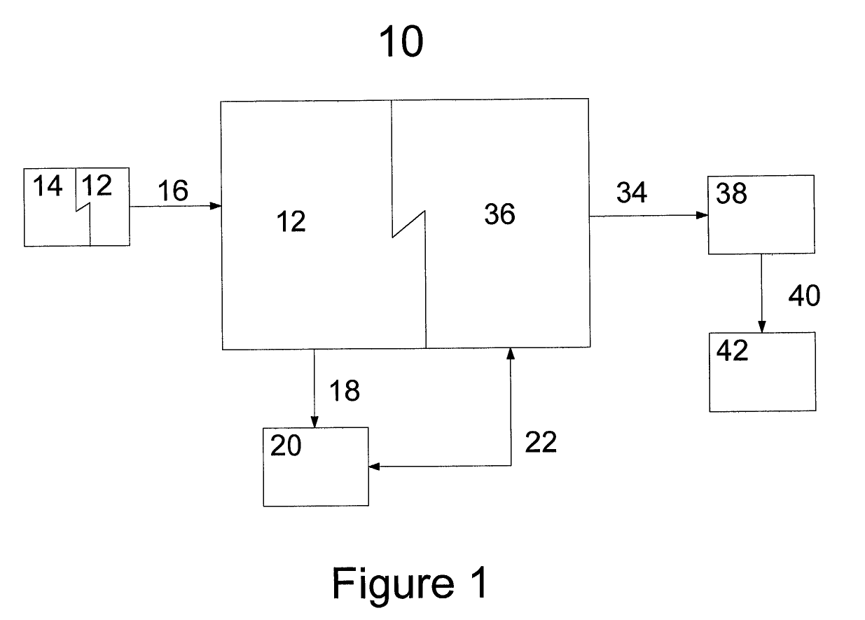

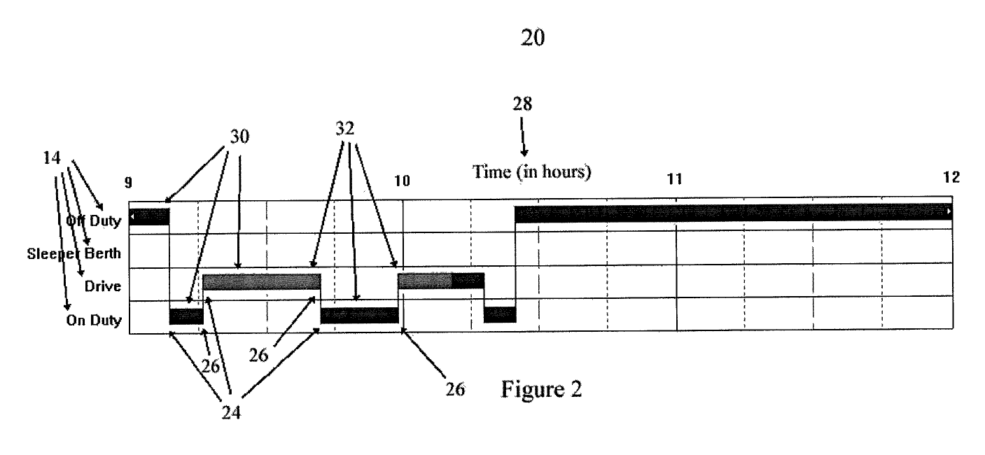

This invention is a data editor 10, shown in FIG. 1, for modifying recorded data 12 based on a finite set of events 14. The data editor includes a data transfer means 16 for loading the recorded data 12 into the editor 10. The data editor 10 also has a graphing means 18 for taking the recorded data 12 and creating a graphic display 20, shown in FIG. 2. Finally, the data editor 10 includes a modifying means 22 for graphically modifying the recorded data 12.

The recorded data 12 for this invention is normally numeric data representing start 24 and stop 26 time of various events 14. The data transfer means 16 could be a modem at the point of recording and another modem at the point of editing for data transmission. The data transfer means 16 could also involve saving the recorded data 12 to a diskette and loading it into a computer with the data editor 10. The data transfer means 16 could also be embodied by any number of means currently known in the art for transferring data, as the method of data transfer is not the novel portion of this invention.

The data graphing means 18 for the data editor 10 creates a graphic display 20 of the recorded data 12. The graphic display 20, shown in FIG. 2, contains time 28 along the vertical axis and events 14 on the horizontal axis. The vertical bars 30 represent graphically display durations 32, which begin at a start time 24 and end at a stop time 26. In the preferred embodiment the recorded data 12 is only the event 14 start 24 and stop 26 time, however the data editor 10 would retain its inventive features if the recorded data 12 was recorded as durations 32.

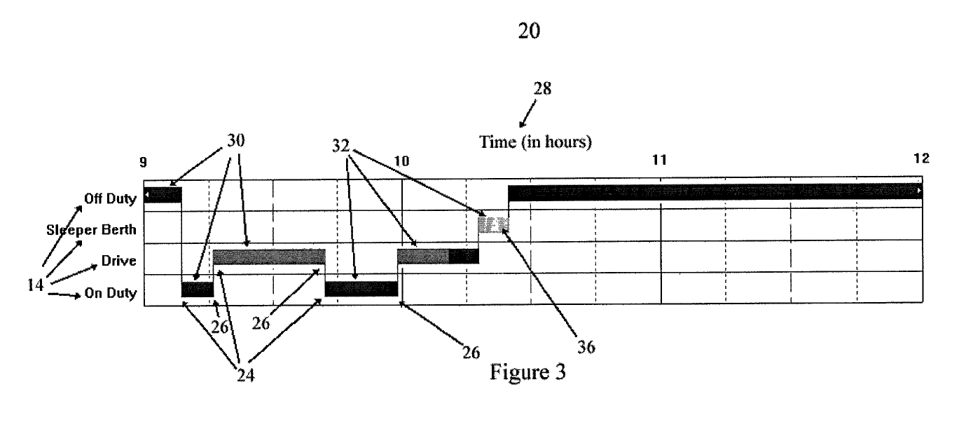

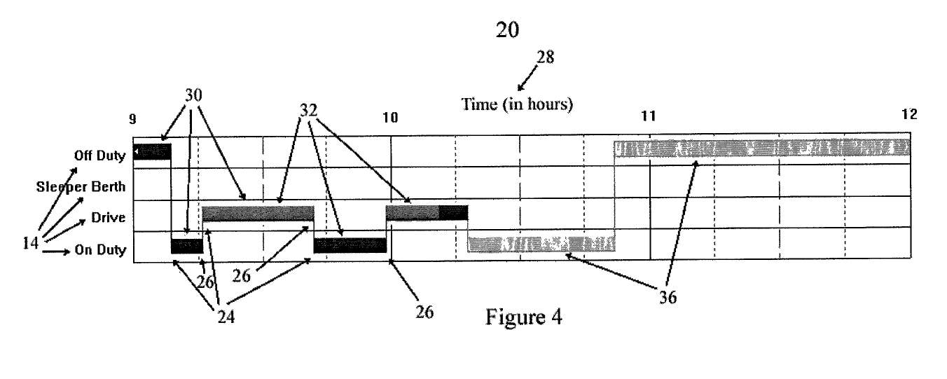

The modifying means 22 is a graphical means of modifying the recorded data 12. In one embodiment, using ‘click and drag’ technology modifies the data 12. ‘Click and drag’ technology involves using an input device to control an onscreen cursor, clicking on an area of the graphical display 20 and dragging a section of the graphical display 20 to another portion of the screen. The disclosed device contemplates ‘clicking and dragging’ start times 24, stop times 26, and durations 32, as well as portions of these elements. FIG. 3 is the same graphical display 20 as FIG. 2, except a single duration 32 has been ‘dragged’ from one event 14 to another. FIG. 4 is the same graphical display 20 as FIG. 2, except one stop time 26 and one start time 24 has been ‘dragged’. The graphical means of modifying may include some numerical editing, such as graphically picking a duration 32, pulling numerical data from the duration 32, editing the numerical data, and having the duration 32 reflect the edited data.

In one embodiment, the data editor 10 may also include a numericizing means 34 for converting the modified data 36 to modified numeric data 38. This embodiment may further include a retransfer means 40 for transferring the modified numeric data 38 to a database 42.

Another embodiment involves both the recorded data 12 and the modified data 36 being saved together. This embodiment of the data editor 10 may further include having both the recorded data 12 and the modified data 36 graphically displayed. The benefit of these embodiments of the invention is that it is beneficial to those people editing the data to be able to see and keep information concerning originally recorded data 12. These features would allow users to edit without fear of losing original data 12. Also, if government entities are interested in the data 12, they need to be able to see the original data 12 to be certain it is not being modified with deceptive intent.

Finally, one other embodiment to the data editor 10 involves editor 10 barring two events 14 from overlapping. This embodiment would enforce its predetermined rule of not allowing overlapping of events 14. One result of this embodiment is that, if a stop time 26 of a duration 32 is dragged past the start time 24 of another event 14, that start time 24 will be dragged as well so that it begins wherever the stop time 26 is left. This can be observed in the difference between FIG. 2 and 4 in which this embodiment of the invention was used. The stop time 26 of one event 14 was ‘dragged’ to a later point in time 28, pushing the start time 24 of the subsequent event 14 back to the same point in time 28.

It is conceivable that the government could require more events 14 than presently required, some of which would overlap, or that trucking companies would be interested in adding events 14 that overlap. Therefore, the specific rule in the immediately preceding embodiment is not central to the invention. One example of an occurrence of overlapping events 14 would be having an on-duty driving event 14, a highway-driving event 14, and a non-highway-driving event 14. If these three events 14 were to be monitored, any time a truck driver was driving, two events 14 would be required to be active and overlapping. At present, the government does not require any elements 14 to be overlapping and, in fact, none of the existing required elements 14 can be overlapping according to U.S. government laws.

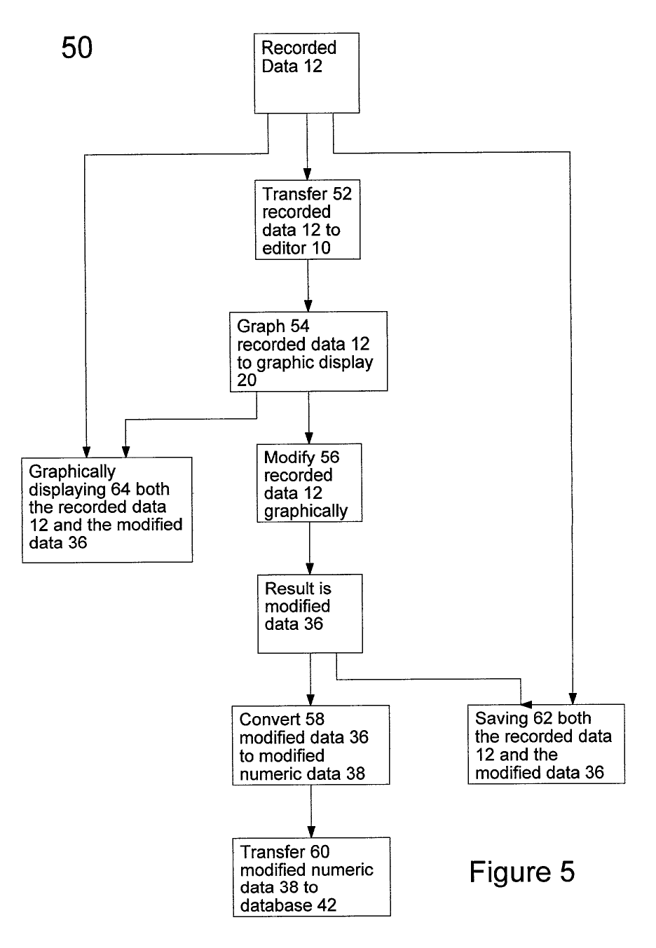

This invention also covers a data editing method 50, shown in FIG. 5, for modifying recorded data 12 based on a finite set of events 14. The first step for the editing method 50 is transferring 52 the recorded data 12 into a data editor 10. The next step involves graphing 54 the recorded data 12 on a graphic display 20. The final step in the editing method 50 is modifying 56 the recorded data 12.

One narrower embodiment of the data editing method 50 includes converting 58 the modified data 36 to a modified numeric data 38. Adding the step of transferring 60 the modified numeric data 38 to a database 42 may further narrow this embodiment.

Another embodiment of this method 50 involves saving 62 both the recorded data 12 and the modified data 36. A similar embodiment involves graphically displaying 64 both the recorded data 12 and the modified data 36.

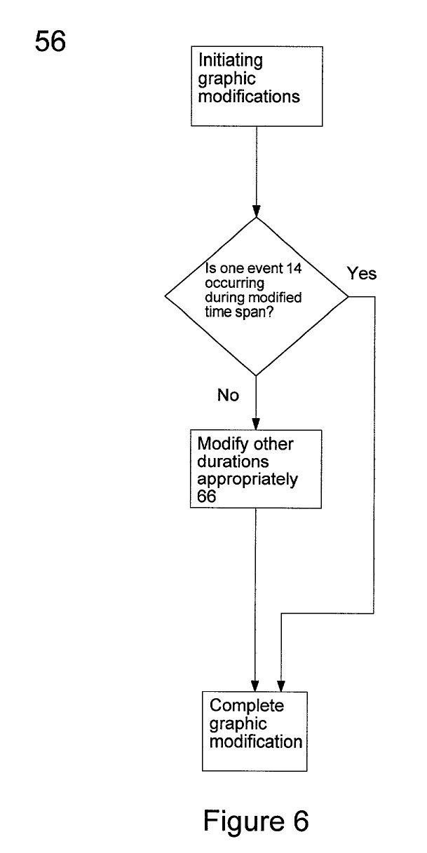

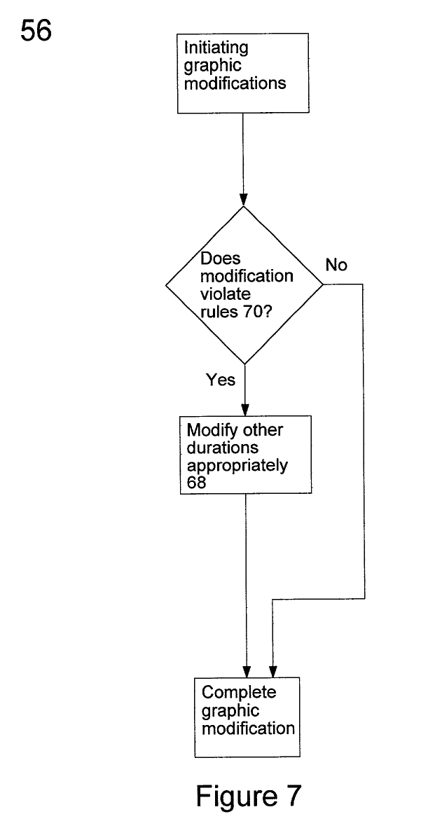

Another embodiment for the data editing method 50, shown in FIG. 6, involves limiting 66 graphical modifying 56 such that during all modified time 28 spans only one event 14 is occurring. A similar embodiment, shown in FIG. 7, involves limiting 68 modifying 56 programmatically with predetermined rules 70. The predetermined rules 70 could include the limitation of only one event 14 occurring in a given time 28 span. The predetermined rules 70 could also include other limitations, such as never allowing a gap to occur (a gap exists when no event 14 is occurring in a given time 28 span) and defaulting to a certain event 14 when a gap does occur. Predetermined rules 70 allows for this method to adapt as the rules employed by the United States Department of Transportation or other governmental agencies evolve.

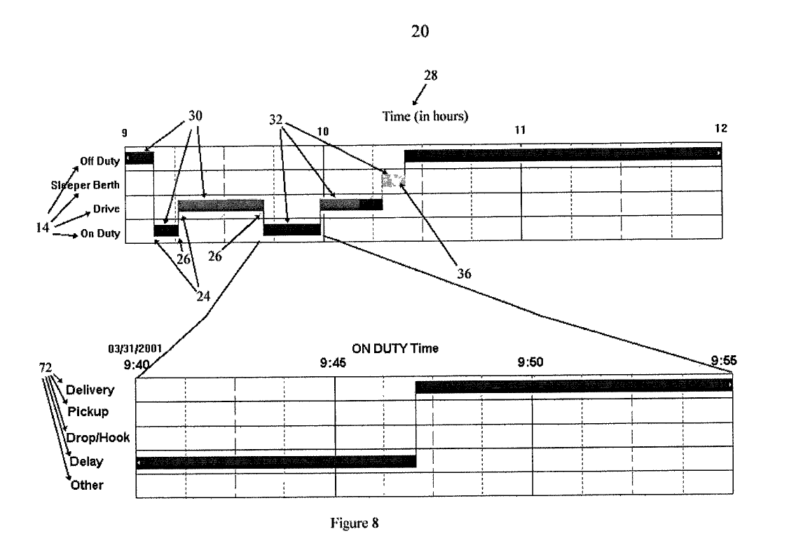

Another embodiment for the data editor 10 and the data editing method 50, shown in FIG. 8, involves allowing for the recorded data 12 to include attributes 72. Attributes 72 are assigned to durations 32. These attributes 72 may include listing on-duty destinations, on-duty purpose, etc. The attributes 72 for a duration 32 may be displayed graphically, as shown in FIG. 8, numerically, or otherwise once a duration 32 has been selected. The usefulness of this embodiment is that while the on-duty duration in FIG. 8 is from 9:40 until about 10:00, different events are occurring in that on-duty duration, such as being delayed by a line of delivery vehicles or interacting with the customer while making a delivery and an employer prefers to see the breakdown of activities occurring within the event 14.

Another embodiment of data editing method 50 involves selecting a duration 80. The second step is having a numerical equivalent of the selected duration appear 82 on the screen. The next step is modifying the numerical equivalent 84 of the selected duration. Once the modification 84 is complete, the final step is having the duration modified 86 as a result of modifying the numerical equivalent.

We claim:

1. A data editor for modifying recorded driver's log data based on a chosen finite set of events, said editor comprising:
a data transfer means for loading the recorded data into the editor;
a graphing means for taking the recorded data and creating a graphic display; and
a modifying means for graphically modifying the recorded data within a predetermined set of rules.

2. The data editor of claim 1 further comprising a numericizing means for converting the modified data to a modified numeric data.

3. The data editor of claim 2 further comprising a retransfer means for transferring the modified numeric data to a database.

4. The data editor of claim 1 wherein both the recorded data and the modified data are saved.

5. The data editor of claim 4 wherein both the recorded data and the modified data are graphically displayed.

6. The data editor of claim 1 wherein the editor bars two events from overlapping.

7. A data editing method for modifying numerically recorded driver's log data based on a chosen finite set of events, said editing method comprising:
transferring the recorded data into a data editor;
graphing the recorded data on an electronic display; and
modifying the recorded data within a predetermined set of rules.

8. The data editing method of claim 7 further comprising converting the modified data to a modified numeric data.

9. The data editing method of claim 8 further comprising transferring the modified numeric data to a database.

10. The data editing method of claim 7 further comprising saving both the recorded data and the modified data.

11. The data editing method of claim 10 further comprising graphically displaying both the recorded data and the modified data.

12. The data editing method of claim 7 wherein the editor limits modifications such that during all modified time spans only one event is occurring.

13. The data editing method of claim 7 wherein the editor limits graphical modifications according to predetermined rules.

14. The data editing method of claim 7 wherein the recorded data includes attributes of driver log data.

15. The data editing method of claim 7 wherein modifying the recorded data further comprises:
selecting a duration;
having a numerical equivalent of the selected duration appear on the screen;
modifying the numerical equivalent of the selected duration; and
having the duration modified as a result of modifying the numerical equivalent.
